(19) United States
(12) Patent Application Publication
(10) Pub. No.: US 2025/0189630 A1
(43) Pub. Date: Jun. 12, 2025

(54) ALIGNMENT DETECTION FOR A VEHICLE RADAR TRANSCEIVER

(71) Applicant: Magna Electronics Sweden AB, Vargarda (SE)

(72) Inventor: Sebastian MARSCH, Niederwerrn (DE)

(73) Assignee: Magna Electronics Sweden AB, Vargarda (SE)

(21) Appl. No.: 18/846,035

(22) PCT Filed: Mar. 17, 2023
(86) PCT No.: PCT/EP2023/056866

§ 371 Date: Sep. 11, 2024

(30) Foreign Application Priority Data
Mar. 23, 2022 (EP) 22163817.4

(51) Int. Cl. G01S 7/40; G01S 13/931

(52) U.S. Cl. CPC G01S 7/4034; G01S 7/4091; G01S 13/931; G01S 2013/93271

(57) ABSTRACT

A measuring system (12) for determining the alignment of a vehicle radar transceiver (3), having a pitch angle (φₚ) and a roll angle (φᵣ). The measuring system (12) is adapted to: transmit radar signals (5), receive reflected radar signals (6) that have been reflected by at least one target object (7), and to determine a determined azimuth angle (θ_{det}) and a determined elevation angle (ψ_{det}) to each target target object (7) relative a reference plane (R) by means of the reflected radar signals (6). The measuring system (12) is further adapted to: assume that each target object (7) and the radar transceiver (3) are positioned in a common plane (P) at a distance (d) from a ground level (G); and to estimate the pitch angle (αₚ) and the roll angle (αᵣ) of the radar transceiver (3) with respect to a fixed coordinate system (x, y, z) using the determined angles (θ_{det}, ψ_{det}) such that the equation

$${ψ}_{det} = a tan ( sin ( {θ}_{det} ) * tan ( {φ}_{r} ) - \frac{cos ( {θ}_{det} ) * tan ( {φ}_{p} )}{cos ( {φ}_{r} )} )$$

is satisfied.

### CROSS-REFERENCE TO RELATED APPLICATIONS

This application is a 35 U.S.C. § 371 national phase of PCT International Application No. PCT/EP2023/056866, filed Mar. 17, 2023, which claims the benefit of priority under 35 U.S.C. § 119 to European Patent Application No. 22163817.4, filed Mar. 23, 2022, the contents of which are incorporated herein by reference in its entirety.

### FIELD OF THE INVENTION

The present disclosure relates to determining the alignment of a vehicle radar transceiver, the alignment being defined by means of a pitch angle, a yaw angle and a roll angle, of the radar transceiver with respect to a fixed coordinate system.

### BACKGROUND

Today, one or more radar transceivers may be mounted on a vehicle in order to detect reflections from surrounding objects in order to implement safety functions such as collision prevention as well as automated/assisted driving. In such a radar transceiver it is required to obtain an azimuth angle in the form of a target bearing angle, a distance with respect to the object, and a relative speed between the vehicle and the object. It is sometimes also necessary to report the elevation angle to the target.

For most vehicle radar applications it is important to measure the azimuth angle with a relatively high degree of precision. The angle accuracy of a radar system depends on fundamental parameters like number of receive channels, component tolerances, assembly precision and installation conditions.

A proper radar transceiver orientation when mounted in a vehicle is given when its x- and y-axis span a plane that is parallel to the vehicle's x-y-plane and its x-axis points along a specified mounting boresight direction. The full 3D misalignment is the triple of angles for which the radar sensor, or radar transceiver, has to be rotated to get it from its proper orientation to the actual misaligned orientation. The first rotation is around its z-axis and is called yaw. The second rotation is around its Y axis and is called pitch and the third rotation is around its x-axis, it is called roll.

To transform a target coordinate from a radar transceivers coordinate system to a vehicle coordinate system it is crucial to know the full position and orientation of the radar transceivers coordinate system in the vehicle coordinate system. Due to mounting tolerances or due to impact of an accident it is possible that the radar sensor is misaligned in the pitch angle and/or the roll angle also. In this case a correct transform of radar targets to other coordinate systems (e.g. car coordinate system) is not possible, if the pitch and roll misalignment is not known. Additionally it is not possible to estimate yaw misalignment correctly, if pitch and roll misalignment are not known.

Radar transceivers can furthermore be affected by various vehicle components such as different types of bumpers and vehicle front and rear section geometries. Radar transceivers are also affected by variations during manufacturing and assembly. Sensor systems therefore require calibration to produce accurate sensor output signals. This calibration is often performed during manufacture in a factory, which is time-consuming and drives cost. Optimal calibration parameters may also change over time, which necessitates a re-calibration, which may be inconvenient.

It is an object of the present disclosure to present an alternative and less complicated method and system for detecting alignment and possible misalignment of a radar transceiver.

### SUMMARY OF EXEMPLARY EMBODIMENTS OF THE INVENTION

The above-described object is achieved by means of a measuring system for determining the alignment of a vehicle radar transceiver, the alignment being defined by means of a pitch angle φₚ and a roll angle φᵣ of the radar transceiver with respect to a fixed coordinate system. The measuring system comprises a radar system that in turn comprises the radar transceiver and a control unit. The measuring system is adapted to transmit radar signals, receive reflected radar signals that have been reflected by at least one target object, and to determine a determined azimuth angle θ_{det} and a determined elevation angle ψ_{det} to each target target object relative a reference plane R by means of the reflected radar signals. The measuring system is further adapted to assume that each target object and the radar transceiver are positioned in a common plane P at a distance d from a ground level G, and to estimate the pitch angle αₚ and the roll angle αᵣ of the radar transceiver with respect to a fixed coordinate system using the determined angles θ_{det}, ψ_{det} such that the equation

$${ψ}_{det} = a tan ( sin ( {θ}_{det} ) * tan ( {φ}_{r} ) - \frac{cos ( {θ}_{det} ) * tan ( {φ}_{p} )}{cos ( {φ}_{r} )} )$$

is satisfied.

This means that an accurate estimation of pitch angle αₚ the roll angle αᵣ or the radar transceiver with respect to a fixed coordinate system can be obtained in a relatively uncomplicated manner. This estimation is based on the assumption that each target object and the radar transceiver are positioned in a common plane, and is based on the inventor's insight regarding how the pitch angle αₚ and the roll angle αᵣ affect the determined azimuth angle θ_{det} and a determined elevation angle ψ_{det}.

According to some aspects, the measuring system is adapted to satisfy the equation by using a non-linear least square fit.

According to some aspects, the measuring system is adapted to satisfy the equation using Bayesian inference.

This means that well-known methods can be used to provide the desired estimation. Many other numerical methods are of course applicable.

This object is also achieved by means of methods and vehicles that are associated with the above advantages.

### BRIEF DESCRIPTION OF THE DRAWINGS

The present disclosure will now be described more in detail with reference to the appended drawings, where:

FIG. 1 shows a schematic top view of a vehicle and a measuring system;

FIG. 2 shows a schematic side view of a radar transceiver and a target object;

FIG. 3 shows a schematic perspective view of the radar transceiver in a coordinate system;

FIG. 4 shows a schematic first view of the radar transceiver in the coordinate system;

FIG. 5 shows a schematic second view of the radar transceiver in the coordinate system;

FIG. 6 shows a schematic third view of the radar transceiver in the coordinate system;

FIG. 7 shows a schematic side perspective view of a radar transceiver target objects;

FIG. 8A-8D illustrate azimuth cuts for different determined azimuth angles;

FIG. 9 shows a graphical representation of how determined azimuth angle and determined elevation angle relate to each other for a certain misalignment;

FIG. 10 illustrates nonlinear parameter optimization for a cross traffic scenario with no mounting error;

FIG. 11 illustrates nonlinear parameter optimization for a cross traffic scenario with no mounting error;

FIG. 12 illustrates nonlinear parameter optimization for a cross traffic scenario with a mounting error;

FIG. 13 illustrates nonlinear parameter optimization for a cross traffic scenario with a mounting error;

FIG. 14-16 illustrate Bayesian inference for a cross traffic scenario with no mounting error;

FIG. 17-19 illustrate Bayesian inference for a cross traffic scenario with a mounting error;

FIG. 20 schematically illustrates a control unit;

FIG. 21 shows an example computer program product; and

FIG. 22 shows a flowchart for methods according to the present disclosure.

### DETAILED DESCRIPTION

Aspects of the present disclosure will now be described more fully with reference to the accompanying drawings. The different devices and methods disclosed herein can, however, be realized in many different forms and should not be construed as being limited to the aspects set forth herein. Like numbers in the drawings refer to like elements throughout.

The terminology used herein is for describing aspects of the disclosure only and is not intended to limit the disclosure. As used herein, the singular forms “a”, “an” and “the” are intended to include the plural forms as well, unless the context clearly indicates otherwise.

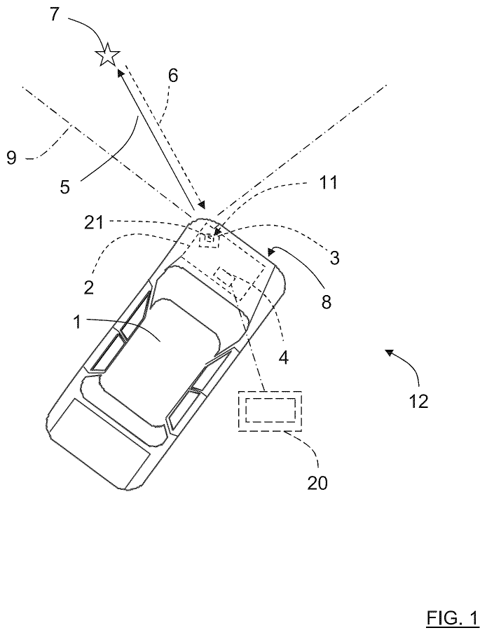

FIG. 1 shows a top view of a vehicle 1 that comprises a radar system 2 that in turn comprises a vehicle radar transceiver 3 and a control unit 4. The radar transceiver 3 has a certain field of view (FOV) 9 and a front side 11 comprising a radar aperture.

According to some aspects, the radar transceiver 3 is positioned behind or inside a bumper 8 which serves as a radome for the radar transceiver 3.

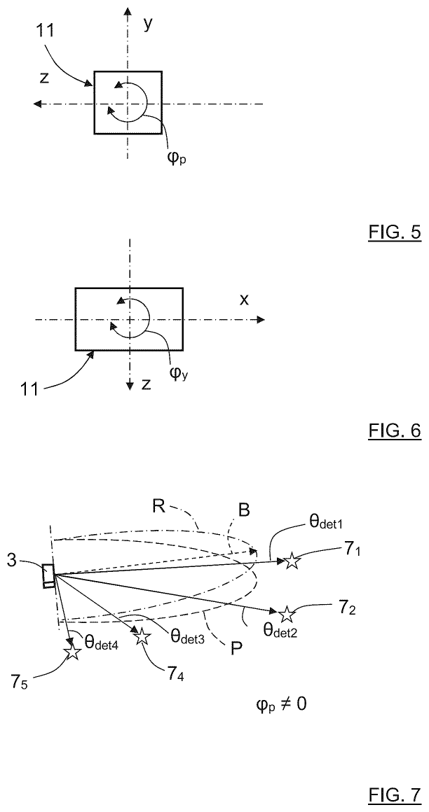

FIG. 1 further shows a measuring system 12 for determining the alignment of the vehicle radar transceiver 3, where the alignment is defined by means of a pitch angle φₚ, a yaw angle φ_{y} and a roll angle φᵣ of the radar transceiver 3 with respect to a fixed coordinate system x, y, z as shown in FIG. 3-6. FIG. 3 shows a schematic perspective view of the radar transceiver 3 in a coordinate system x, y, z, and FIG. 4-FIG. 6 show a schematic views of the radar transceiver 3 with its front side 11 in the coordinate system x, y, z, illustrating the pitch angle φₚ, the yaw angle φ_{y} and the roll angle φᵣ of the radar transceiver 3.

The measuring system 12 comprises the radar system 2 that in turn comprises the radar transceiver 3 and the control unit 4. According to some aspects, the measuring system 12 further comprises at least one target object 7, for example when the target object 7 is comprised in a predetermined test set-up.

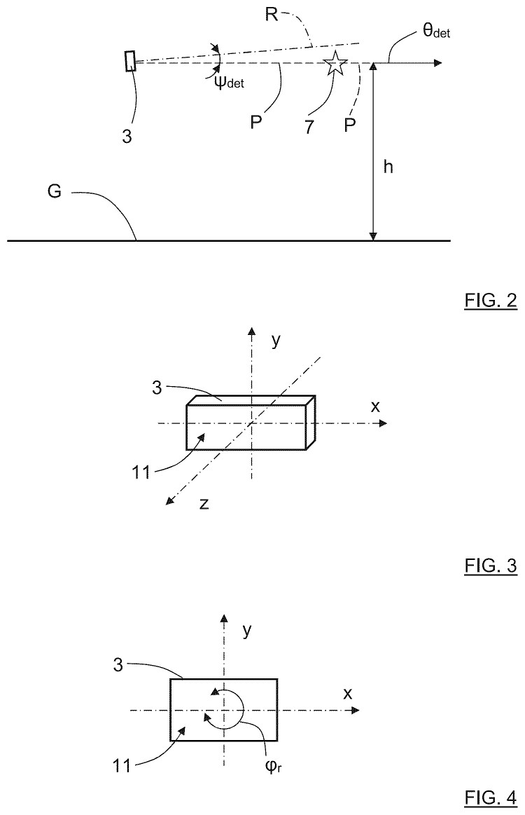

With reference also to FIG. 2, the measuring system 12 is adapted to transmit radar signals 5, to receive reflected radar signals 6 that have been reflected by the target object 7, and to determine a determined azimuth angle θ_{det} and a determined elevation angle ψ_{det} to the target object 7 relative a reference plane R by means of the reflected radar signals 6.

For this purpose, the radar transceiver 3 is adapted to transmit radar signals 5 and receive reflected radar signals 6 that have been reflected by a target object 7. The control unit 4 is adapted to control the radar transceiver 3, for example transmission timing, transmission frequency content, as well as the actual transmitted time waveform. The control unit 4 is according to some aspects also adapted to perform signal processing in order to extract target data related to the detected target objects, for example 2D FFT for obtaining a Range-Doppler matrix in a previously well-known manner. According to some aspects, the control unit 4 is connected to an external computer device 20.

According to the present disclosure, the measuring system 12 is further adapted to assume that the target object 7 and the radar transceiver 3 are positioned in a common plane P at a distance d from a ground level G, and to estimate the pitch angle αₚ and the roll angle αᵣ of the radar transceiver 3 with respect to a fixed coordinate system x, y, z using on the determined angles θ_{det}, ψ_{det} such that the equation

$${ψ}_{det} = a tan ( sin ( {θ}_{det} ) * tan ( {φ}_{r} ) - \frac{cos ( {θ}_{det} ) * tan ( {φ}_{p} )}{cos ( {φ}_{r} )} ) \qquad ( 1 )$$

is satisfied.

This means that an accurate estimation of pitch angle αₚ the roll angle αᵣ of the radar transceiver 3 with respect to a fixed coordinate system x, y, z can be obtained in a relatively uncomplicated manner.

According to some aspects, the measuring system 12 comprises target objects 7 that have been determined to be moving.

The present disclosure is based on the inventor's insight regarding how the pitch angle αₚ and the roll angle αᵣ affect the determined azimuth angle θ_{det} and a determined elevation angle ψ_{det}.

This is illustrated in FIG. 7 where there is a certain error due to pitch misalignment such that φₚ≠0. This means that, depending on the determined azimuth angle θ_{det1}, θ_{det2}, θ_{det3}, θ_{det4} of the target object 71, 72, 73, 74, the determined elevation angle ψ_{det} will assume different values. The target objects 71, 72, 73, 74 and the radar transceiver 3 are assumed to lie in the common plane P.

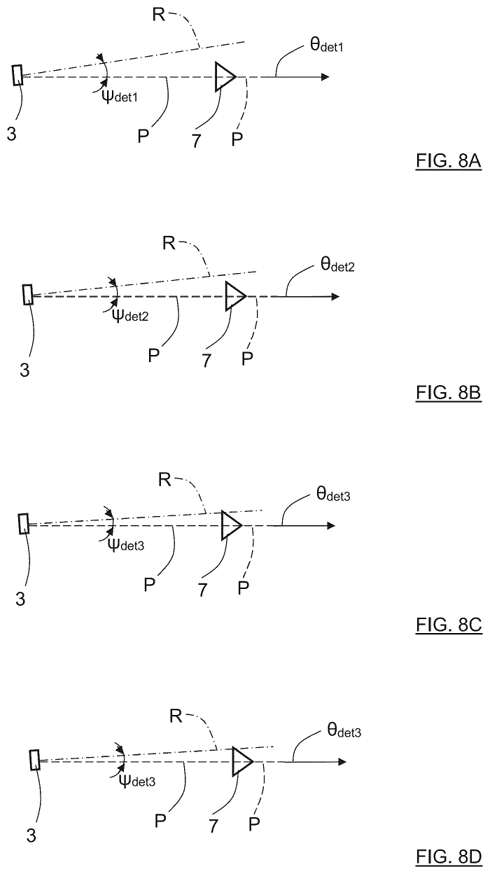

FIG. 8A-FIG. 8D illustrates this by showing corresponding azimuth cuts for the different determined azimuth angles θ_{1det}, θ_{2det}, θ_{3det}, θ_{4det} of the target object 71, 72, 73, 74 as illustrated in FIG. 7.

FIG. 8A shows a case where there is a first target object 71 at a first determined azimuth angle θ_{det1} and at a first determined elevation angle ψ_{det1}.

FIG. 8B shows a case where there is a second target object 72 at a second determined azimuth angle θ_{det2} and at a second determined elevation angle ψ_{det2}.

FIG. 8C shows a case where there is a third target object 73 at a third determined azimuth angle θ_{det3} and at a third determined elevation angle ψ_{det3}.

FIG. 8D shows a case where there is a fourth target object 74 at a fourth determined azimuth angle θ_{4det} and at a fourth determined elevation angle ψ_{det4}.

The larger the determined azimuth angle becomes relative a boresight direction B, the smaller the determined elevation angle becomes due to the pitch misalignment that separates the common plane P from the reference plane R.

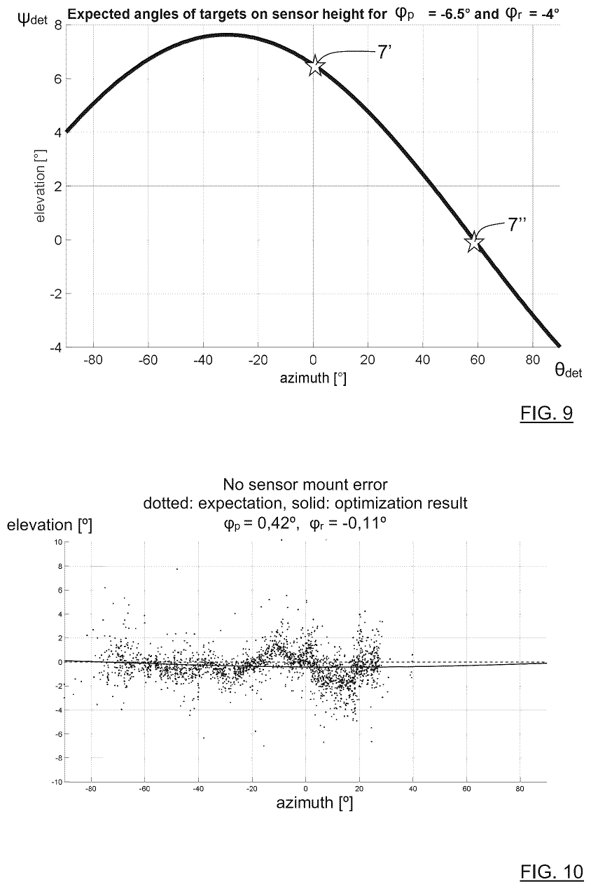

FIG. 9 provides a graphical representation of how the determined azimuth angle and the determined elevation angle relates to each other for a pitch misalignment of φₚ=−6.5° and a roll misalignment of φᵣ=−4.0°. For example, a target object 7′ that is detected at determined azimuth angle θ_{det}=0.0° will approximately result in a determined elevation angle ψ_{det}=6.5°, and a target object 7″ that is detected at determined elevation angle ψ_{det}=0.0° will approximately result in a determined azimuth angle θ_{det}≈59°.

Different determined values for determined azimuth angle θ_{det} and determined elevation angle ψ_{det} can thus be used to determine the pitch alignment error and the roll alignment error by finding these angular values φₚ, φᵣ that satisfy equation (1) above for at least one determined azimuth angles θ_{det} and at least one determined elevation angles ψ_{det}. Typically, a plurality of detections are used.

According to some aspects, the boresight direction B lies in the reference plane R.

Different numerical methods can be used to solve for the pitch misalignment angle φₚ and the roll misalignment angle φᵣ. Examples of cases using different numerical methods will be disclosed in the following.

According to some aspects, with reference to FIG. 10-13, the measuring system 12 is adapted to satisfy the equation by using a non-linear least square fit by means of nonlinear parameter optimization. In the examples described, there is a cross traffic scenario with five crossing cars, and the radar transceiver 3 is mounted behind the bumper 8.

FIG. 10 illustrates a nonlinear parameter optimization without any mounting error, i.e., with a pitch misalignment of φₚ=0° and a roll misalignment of φᵣ=0° where the resulting calculated pitch misalignment is φₚ=0.42° and the resulting calculated roll misalignment is φᵣ=−0.11°. The dots relate to expectation and the solid line relates to the result of the nonlinear parameter optimization, both as a function of azimuth angle and elevation angle.

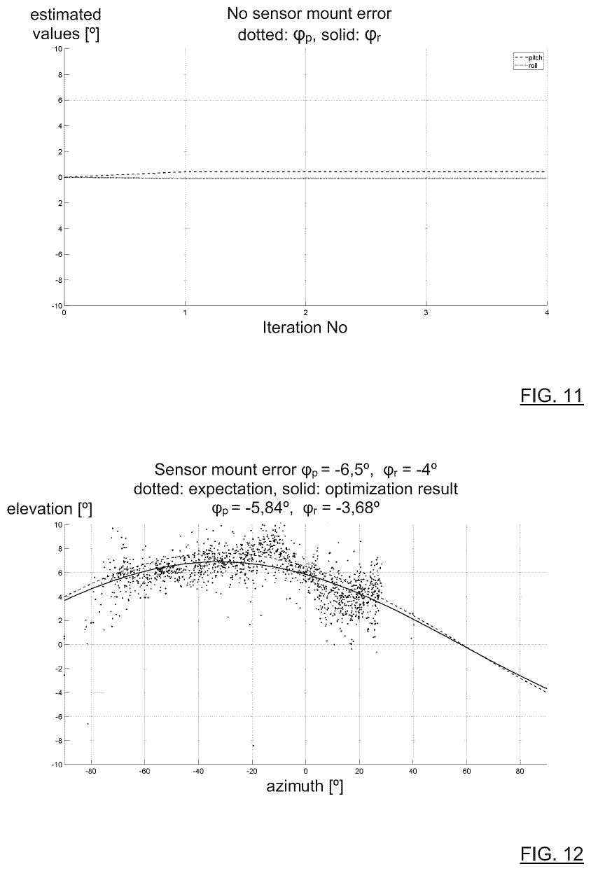

FIG. 11 illustrates the estimated parameter values shown as a function of the number of iterations for the parameter optimization described above with reference to FIG. 10. The x-axis shows the number of iteration, and the y-axis shows the estimated parameter values.

FIG. 12 illustrates a nonlinear parameter optimization with a with a pitch misalignment of φₚ=−6.5° and a roll misalignment of φᵣ=−4.0°, where the resulting calculated pitch misalignment is φₚ=−5.84° and the resulting calculated roll misalignment is φᵣ=−3.68°. The dots relate to expectation and the solid line relates to the result of the nonlinear parameter optimization, both as a function of azimuth angle and elevation angle.

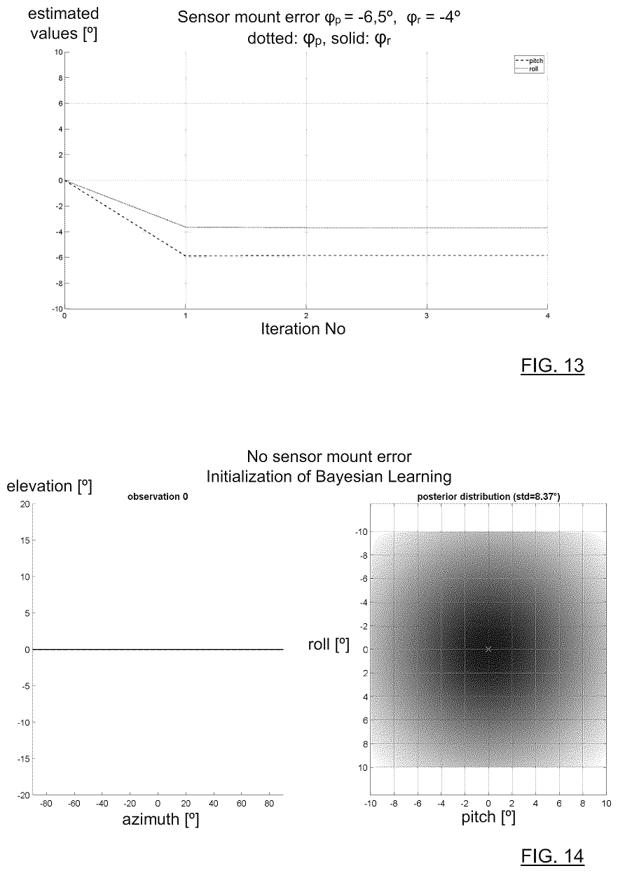

FIG. 13 illustrates the estimated parameter values shown as a function of the number of iterations for the parameter optimization described above with reference to FIG. 12. The x-axis shows the number of iteration, and the y-axis shows the estimated parameter values.

According to some aspects, with reference to FIG. 14-19, the measuring system 12 is adapted to satisfy the equation by using Bayesian inference. In the examples described, there is a cross traffic scenario with five crossing cars, and the radar transceiver 3 is mounted behind the bumper 8.

FIGS. 14-FIG. 19 visualize the mechanics of Bayesian inference where an observation of detected target objects is used to refine knowledge about the parameters that is present in the form of a distribution. A prior parameter distribution is updated with each observation to a posterior parameter distribution. As more and more observations of detected target objects get observed the posterior distribution gets sharper over time. In each left-hand diagram, the x-axis shows an azimuth angle and the y-axis shows an elevation angle for the observations. In each right-hand diagram the x-axis shows a radar transceiver pitch misalignment angle, and the y-axis shows a radar transceiver roll misalignment angle.

In FIG. 14-FIG. 16 there is no mounting error, i.e., there is a pitch misalignment of φₚ=0° and a roll misalignment of φᵣ=0°.

In FIG. 14, after 0 observations, no observation of detected target objects has been captured, so the distribution of pitch and roll is the initial distribution. The resulting calculated pitch misalignment is φₚ=0° and the resulting calculated roll misalignment is φᵣ=0°.

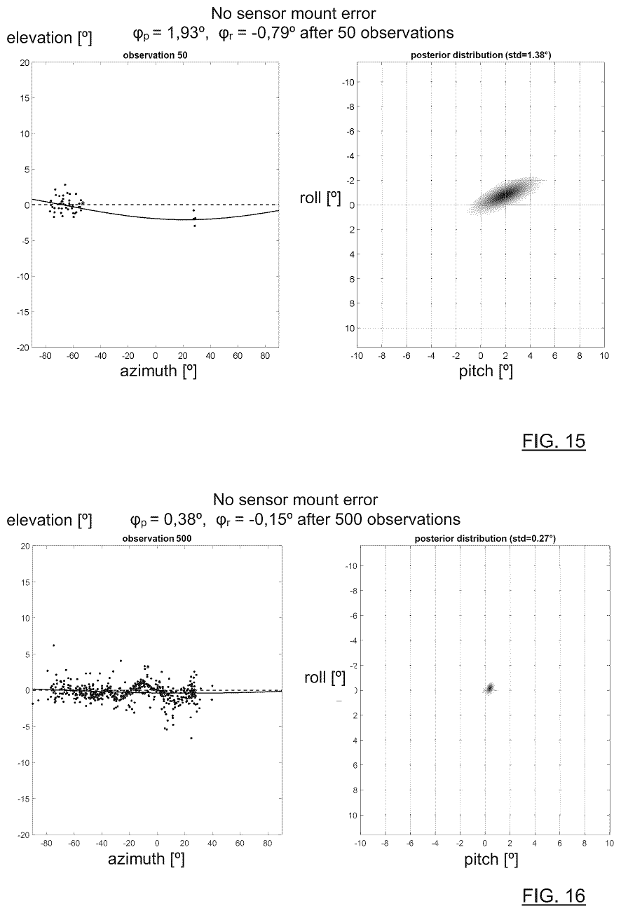

FIG. 15 shows the posterior distribution after 50 observations; the resulting calculated pitch misalignment is φₚ=1.93° and the resulting calculated roll misalignment is φᵣ=−0.79°.

FIG. 16 shows the posterior distribution after 500 observations; the resulting calculated pitch misalignment is φₚ=0.38° and the resulting calculated roll misalignment is φᵣ=−0.15°. The result is very precise at this time, and thus an estimation for the parameters pitch misalignment angle φₚ and roll misalignment angle φᵣ can be determined.

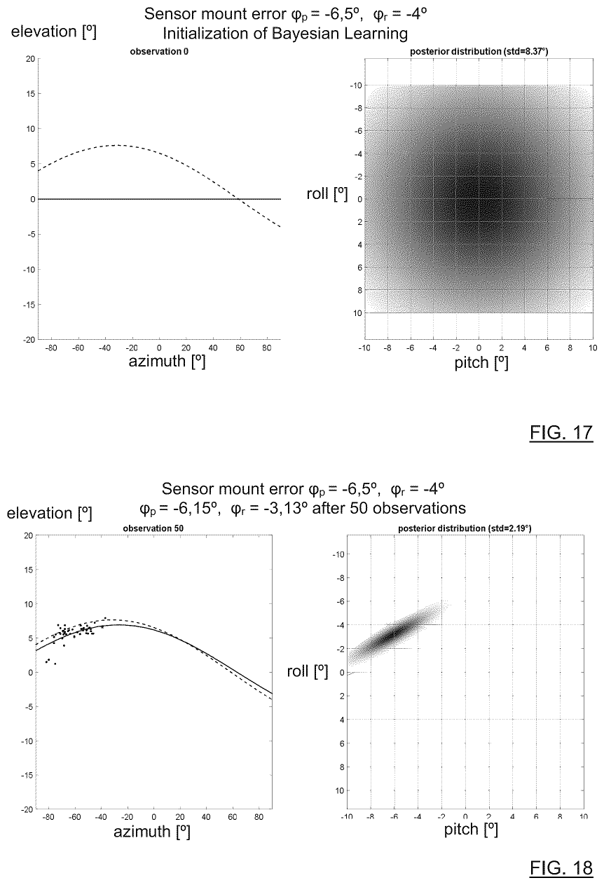

In FIG. 17-FIG. 19 there is a mounting error; there is a pitch misalignment of φₚ=−6.5° and a roll misalignment of φᵣ=−4°.

In FIG. 17, after 0 observations, no observation of detected target objects has been captured, so the distribution of pitch and roll is the initial distribution. The resulting calculated pitch misalignment is φₚ=0° and the resulting calculated roll misalignment is φᵣ=0°.

FIG. 18 shows the posterior distribution after 50 observations; the resulting calculated pitch misalignment is φₚ=−6.15° and the resulting calculated roll misalignment is φᵣ=−3.13°.

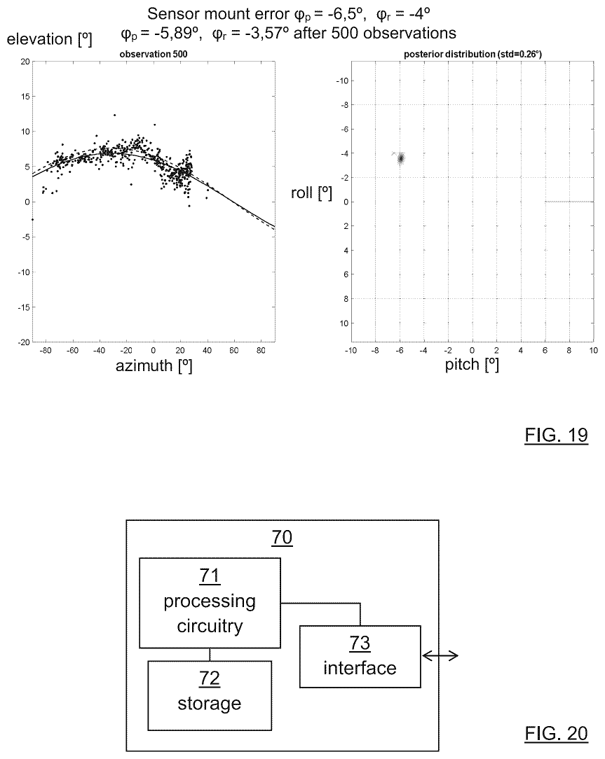

FIG. 19 shows the posterior distribution after 500 observations; the resulting calculated pitch misalignment is φₚ=−5.89° and the resulting calculated roll misalignment is φᵣ=−3.57°. The result is very precise at this time, and thus an estimation for the parameters pitch misalignment angle φₚ and roll misalignment angle φᵣ can be determined.

Only one implementation example has been provided for each one of the numerical methods described above, there are of course many other ways to implement these methods.

Furthermore, the numerical methods described above only present examples of how to derive the pitch misalignment angle φₚ and the roll misalignment angle φᵣ, many other such numerical methods are of course conceivable and apparent for the skilled person.

According to some aspects, having determined the pitch misalignment angle φₚ and the roll misalignment angle φᵣ, these can be stored in a memory and used by the control unit 4 that is adapted to performed a compensation for following detections of target objects such that the determined pitch misalignment angle φₚ and the roll misalignment angle φᵣ are compensated for.

As described more in detail below, a control unit and a computer program can according to some aspects be used to determine the most likely misalignment values of pitch angle φₚ and roll angle φᵣ.

FIG. 20 schematically illustrates, in terms of a number of functional units, the components of a control unit 70, corresponding to the control unit 4 described, according to an embodiment. Processing circuitry 71 is provided using any combination of one or more of a suitable central processing unit (CPU), multiprocessor, microcontroller, digital signal processor (DSP), dedicated hardware accelerator, etc., capable of executing software instructions stored in a computer program product, e.g. in the form of a storage medium 72. The processing circuitry 71 may further be provided as at least one application specific integrated circuit (ASIC), or field programmable gate array (FPGA).

Particularly, the processing circuitry 71 is configured to cause the control unit 70 to perform a set of operations, or steps. These operations, or steps, were discussed above in connection to the various measuring systems 12 and methods. For example, the storage medium 72 may store the set of operations, and the processing circuitry 71 may be configured to retrieve the set of operations from the storage medium 72 to cause the control unit 70 to perform the set of operations. The set of operations may be provided as a set of executable instructions. Thus, the processing circuitry 71 is thereby arranged to execute methods and operations as herein disclosed.

The storage medium 72 may also comprise persistent storage, which, for example, can be any single one or combination of magnetic memory, optical memory, solid state memory or even remotely mounted memory.

The control unit 70 may further comprise a communications interface 73 for communications with at least one other unit. As such, the interface 73 may comprise one or more transmitters and receivers, comprising analogue and digital components and a suitable number of ports for wired or wireless communication.

The processing circuitry 71 is adapted to control the general operation of the control unit 70 e.g. by sending data and control signals to the external unit and the storage medium 72, by receiving data and reports from the external unit, and by retrieving data and instructions from the storage medium 72. Other components, as well as the related functionality, of the control unit 70 are omitted in order not to obscure the concepts presented herein.

FIG. 21 shows a computer program product 81 comprising computer executable instructions 82 arranged on a computer readable medium 83 to execute any of the methods disclosed herein.

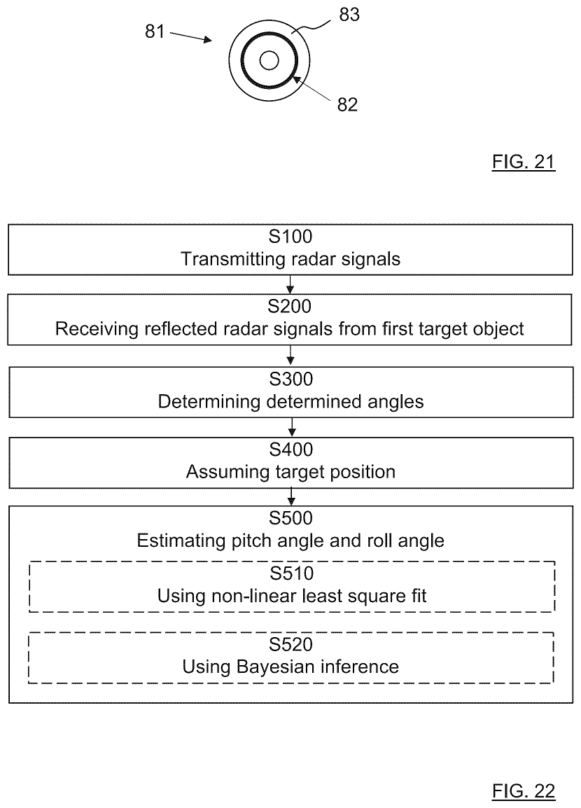

With reference to FIG. 22, the present disclosure also relates to a method for determining the alignment of a vehicle radar transceiver 3, the alignment being defined by means of a pitch angle φₚ and a roll angle φᵣ of the radar transceiver 3 with respect to a fixed coordinate system x, y, z. The method comprises transmitting at step S100 radar signals 5, receiving at step S200 reflected radar signals 6 that have been reflected by at least one target object 7, and determining at step S300 a determined azimuth angle θ_{det} and a determined elevation angle ψ_{det} to each target object 7 relative a reference plane R using the reflected radar signals 6.

The method further comprises assuming at step S400 that each target object 7 and the radar transceiver 3 are positioned in a common plane P at a distance h from a ground level G; and estimating at step S500 the pitch angle αₚ and the roll angle αᵣ of the radar transceiver 3 with respect to a fixed coordinate system x, y, z using the determined angles θ_{det}, ψ_{det} such that the equation

$${ψ}_{det} = a tan ( sin ( {θ}_{det} ) * tan ( {φ}_{r} ) - \frac{cos ( {θ}_{det} ) * tan ( {φ}_{p} )}{cos ( {φ}_{r} )} )$$

is satisfied.

According to some aspects, the method comprises using target objects 7 that have been determined to be moving.

According to some aspects, the method comprises satisfying at step S510 the equation by using a non-linear least square fit.

According to some aspects, the method comprises satisfying at step S520 the equation by using Bayesian inference.

The present disclosure is not limited to the examples discussed, but may vary freely within the scope of the appended claims. For example, the radar transceivers can be of any suitable kind, and can according to some aspects comprise suitable devices such as antennas, transmitters, receivers, control units etc.

The control unit 4 may be constituted by one unit or by two or more distributed sub-units. The control unit 4 can according to some aspects be adapted to perform one or more of the steps described to be performed by the measuring system 12.

The present disclosure can be applied to any suitable radar transceiver or radar transceivers comprised in the radar system 2.

The present disclosure is for example useful in the cases where the radar transceiver 3 is not accessible to the person performing an alignment test, e.g. to put a tilt meter on it. Hence the person performing an alignment test requires a way to know that the radar transceiver 3 is aligned on the vehicle within the tolerance agreed by the radar manufacturer, which is provided by means of the present disclosure.

According to some aspects, alignment of the radar transceiver 3 is directed towards alignment of antennas 21 comprised in the radar transceiver 3, the antennas 21 being adapted to transmit radar signals and receive reflected radar signals in a well-known manner. According to some aspects, a radar transceiver 3 is an integrated unit, where an adjustment or misalignment of the radar transceiver 3 directly affects the antennas 21 comprised in the radar transceiver 3.

It should be noted that when it mentioned that each target object 7 and the radar transceiver 3 are positioned in a common plane P at a distance h from a ground level G, this is an assumption that is made. This does not necessarily mean that this is the case in practice.

While the above description constitutes the preferred embodiment of the present invention, it will be appreciated that the invention is susceptible to modification, variation and change without departing from the proper scope and fair meaning of the accompanying claims.

1. A method for determining an alignment of a vehicle radar transceiver, the alignment being defined by a pitch angle (φₚ) and a roll angle (φᵣ) of the radar transceiver with respect to a fixed coordinate system, where the method comprises the steps of:
transmitting radar signals;
receiving reflected radar signals that have been reflected by at least one target object;
determining a determined azimuth angle (θ_{det}) and a determined elevation angle (ψ_{det}) to each of the at least one target object relative a reference plane using the reflected radar signals;
assuming (S400) that each of the at least one target object and the radar transceiver are positioned in a common plane at a distance from a ground level; and
estimating an estimated pitch angle (αₚ) and an estimated roll angle (αᵣ) of the radar transceiver with respect to the fixed coordinate system using the determined angles (θ_{det}, ψ_{det}) such that the equation;
$${ψ}_{det} = a tan ( sin ( {θ}_{det} ) * tan ( {φ}_{r} ) - \frac{cos ( {θ}_{det} ) * tan ( {φ}_{p} )}{cos ( {φ}_{r} )} )$$
is satisfied.

2. The method according to claim 1, wherein the method further comprises using one of the at least one target object that has been determined to be moving.

3. The method according to claim 1, wherein the method further comprises satisfying the equation by using a non-linear least square fit.

4. The method according to claim 1, wherein the method further comprises satisfying the equation by using a Bayesian inference.

5. A measuring system for determining an alignment of a vehicle radar transceiver, the alignment being defined by a pitch angle (φₚ) and a roll angle (φᵣ) of the radar transceiver with respect to a fixed coordinate system, where the measuring system comprises a radar system, the radar transceiver and a control unit, where the measuring system is adapted to:
transmit radar signals,
receive reflected radar signals that have been reflected by at least one target object, and to
determine a determined azimuth angle (θ_{det}) and a determined elevation angle (ψ_{det}) to each of the at least one target object relative a reference plane using the reflected radar signals;
wherein that the measuring system further is adapted to:
assume that each of the at least one target object and the radar transceiver are positioned in a common plane at a distance from a ground level; and to
estimate an estimated pitch angle (αₚ) and an estimated roll angle (αᵣ) of the radar transceiver with respect to a fixed coordinate system using the determined angles (θ_{det}, ψ_{det}) such that the equation
$${ψ}_{det} = a tan ( sin ( {θ}_{det} ) * tan ( {φ}_{r} ) - \frac{cos ( {θ}_{det} ) * tan ( {φ}_{p} )}{cos ( {φ}_{r} )} )$$
is satisfied.

6. The measuring system according to claim 5, wherein the measuring system comprises the at least one target object that has been determined to be moving.

7. The measuring system according to claim 5, wherein the measuring system is adapted to satisfy the equation by using a non-linear least square fit.

8. The measuring system according to claim 5, wherein the measuring system is adapted to satisfy the equation using a Bayesian inference.

9. A vehicle comprising the measuring system according to claim 5.
